(19) United States
(12) Patent Application Publication
(10) Pub. No.: US 2013/0191574 A1
(43) Pub. Date: Jul. 25, 2013

(54) AUDIO PLAYER

(71) Applicant: Takahito Tezuka, Nagano (JP)

(72) Inventor: Takahito Tezuka, Nagano (JP)

(73) Assignee: SHINANO KENSHI KABUSHIKI KAISHA, Ueda-shi (JP)

(21) Appl. No.: 13/355,093

(22) Filed: Jan. 20, 2012

(51) Int. Cl. G06F 13/00

(52) U.S. Cl. 710/301

(57) ABSTRACT

The audio player 30, to which a cartridge 10 storing digital audio data of a book for the visually impaired can be attached, is capable of reproducing the audio data read from the cartridge 10, an accommodating section 40, into which the cartridge 10 can be inserted in a state where the thickness direction of the cartridge is arranged in the vertical direction, is formed in a front wall 30a, and a part of a flat surface of the inserted cartridge 10 is exposed from the accommodating section 40.

### FIELD

The present invention relates to an audio player for the visually impaired, which is capable of reproducing audio data as audio.

### BACKGROUND

Digital audio books, which meet ANSI/NISO Z39.86 Specifications for the Digital Talking Book and which reproduce audio data of sentences of books for the visually impaired, have been known.

Digital audio data meeting the ANSI/NISO Z39.86 Specifications can be stored in various types of storage media, but the data are usually stored in specially-shaped recording media (e.g., cartridges), which are disclosed in, for example, Patent Document 1 (U.S. Pat. No. 8,049,991) and Patent Document 2 (USD 579940), because the recording media are used by the visually impaired.

Each of the cartridges has a main body section composed of plastic, and a memory, e.g., flash memory, is accommodated in the main body section. Digital audio data of books are stored in the memory.

Each of the cartridges is formed into a thin rectangular parallelepiped and is similar in size to a cassette tape, and a USB plug is provided to one of short sides of the planar rectangle shape. The memory in the cartridge is connected to an audio player, described later, by the USB connection, and the digital audio data stored in the memory of the cartridge are read by the audio player.

Audio players, to which the above described cartridges can be attached and which are capable of reproducing digital audio data of books, are disclosed in Patent Document 1 (U.S. Pat. No. 8,049,991) and Patent Document 3 (USD 582430).

In each of the audio players, an accommodating section, into which the cartridge can be inserted, is opened in a front face so as to attach the cartridge. A width of the accommodating section is gradually increased forward, so that a user, i.e., the visually impaired, can easily insert the cartridge into the accommodating section.

A USB receptacle is provided in the accommodating section so as to connect the USB plug of the cartridge thereto.

When the cartridge is inserted into the accommodating section and the USB plug and receptacle are connected, the audio player is capable of reading digital audio data of books from the cartridge. Then, the audio player is capable of reproducing the digital audio data as audio.

### SUMMARY

In the conventional audio player, when a visually-impaired user tries to insert the cartridge into the accommodating section, the USB plug side of the cartridge must be lifted after confirming the height of the accommodating section, so there is a problem that it takes a long time to insert the cartridge.

Further, as a method for lifting up the USB plug side of the cartridge adequately, it is suggested to press an upper face of the cartridge near backend which has a through-hole by utilizing an inclined bottom face of the cartridge. However, for the visually-impaired user, it is difficult to keep the cartridge on their hand firmly by the lifting action above, then the cartridge is easily detach from a user's hand, e.g., falling the cartridge down from a desk, it is difficult for the visually-impaired user to pick up the cartridge again. So, there is a problem that the user must highly carefully treat the cartridge or must not treat the audio player around an edge of a desk when the users try to insert the cartridge into the player.

Additionally, if liquid or foreign matters invade into the accommodating section, it is difficult to remove the liquid or foreign matters, and the liquid or foreign matters cause poor USB connection or other serious troubles.

Thus, the present invention is invented to solve the above described problems, and an object of the present invention is to provide an audio player, in which a cartridge can be easily inserted into an accommodating section by a visually-impaired user and liquid or foreign matters can be easily removed from the accommodating section.

In the present invention, the audio player, to which the cartridge storing digital audio data of a book for the visually impaired can be attached, is capable of reproducing the audio data read from the cartridge, an accommodating section, which has an opening part through which the cartridge can be inserted, is formed in at least one of side faces, and the bottom face of the inserted cartridge is exposed from the accommodating section.

With this structure, even if liquid or foreign matters invade into the accommodating section, they can be removed from the exposed part, so maintenance can be easily performed. Poor USB connection or troubles can be prevented. Since the bottom face of the cartridge is exposed, the USB receptacle can be utilized as general USB port. A user can easily know the position of the accommodating section, at which the part of the cartridge is exposed, by touching the audio player. Therefore, after inserting the cartridge into the accommodating section, the user can confirm if the cartridge is securely set or not by tactile sensation. In the conventional audio player, the user can assume the condition of the USB connection by only touching an end part of the cartridge which is sticking out from the accommodating section; on the other hand, the bottom face of the cartridge is exposed, so that the user can surely confirm if the cartridge is securely set in the accommodating section or not by touching them. Further, a position of a through-hole of the cartridge can be easily known from the exposed side, so that the cartridge can be pulled out surely.

In the audio player, the accommodating section may be formed in the vicinity of a bottom face of the audio player.

With this structure, a height of the entire audio player can be lowered, so that the audio player can be downsized and made thinner and lighter. Therefore, production materials can be reduced, and a production cost can be reduced. Since the audio player can be downsized and made thinner and lighter, the user can easily carry the audio player.

In the audio player, the accommodating section should be located at a same plane, e.g., desk, where the cartridge is set and inserted into the accommodated section with horizontally moving.

In the conventional audio player, the accommodating section is located at middle height of the audio player, and the vertical position of the cartridge must be adjusted when the visually-impaired user inserts the cartridge into the accommodating section, so the cartridge cannot be inserted smoothly without careful treatments by the user; with the above described structure, the cartridge can be smoothly inserted into the accommodating section without adjusting the vertical position.

In the audio player, the bottom side of the accommodating section may be opened.

In the conventional audio player, it is difficult to remove liquid or foreign matters, which have invaded into the accommodating section. Condition of the conventional audio player will be badly influenced by liquid or foreign matters in the accommodating section.

With the above described structure, liquid or foreign matters fall downward from the accommodating section, liquid or foreign matters do not stay in the audio player, so that the audio player is not badly influenced.

In the audio player, linearly-tapered faces, a width of the accommodating section is gradually increased forward linearly, may not be formed in the vicinity of corners of the opening part of the accommodating section.

With this structure, in case that the cartridge, which is located in the plane where the audio player is set, is inserted into the audio player with horizontally moving, the user inserts a finger into the through-hole of the cartridge so as not to lose the cartridge, one of corners of the cartridge, which is located on the USB plug side, is brought into contact with a surface in the vicinity of the opening part and slid thereon so as to find the opening part and insert the cartridge therein; in this case, no linearly tapered faces are formed in the vicinity of the corners of the opening part, namely discontinuous curves having distinct angles are not formed therein, so that the cartridge can be smoothly inserted without being stuck.

In the audio player, curved parts may be formed in the vicinity of the corners of the opening part of the accommodating section. If the curved parts are formed as smooth curved lines, e.g., circular lines, elliptical lines, quadratic curves, involute curves, the cartridge can be more smoothly inserted by the above described insertion manner, in which one end of the cartridge is slid sideward.

In the audio player, a USB receptacle for electrically connecting to the inserted cartridge may be provided on an innermost face, in the insertion direction, of the accommodating section, and the accommodating section may have a protecting section, which covers the exposed face of the USB receptacle so as not to expose it.

With this structure, the position of the USB receptacle can be known by tactile sensation of a user's hand, so that the user can easily and surely confirm if the cartridge is securely connected to the USB receptacle or not. Injury, which is caused by directly touching the USB receptacle, and troubles of the USB receptacle, which are caused by contact with a foreign matters existing in the plane where the audio player will be set, can be prevented.

In the audio player, a width of the protecting section may be smaller than that of the cartridge so as to form gaps on the both sides, in the width direction, of the protecting section and expose the cartridge in the gaps.

With this structure, the protecting section covers only the vicinity of the USB receptacle, so that liquid or foreign matters, which have invaded, can be removed soon.

In the audio player, a size of the gaps may be 11.5-13.0 mm.

With this structure, when a jig is used to connect a USB cable, etc. to or disconnect the same from the USB receptacle of the audio player, a required space can be formed but inserting a finger can be prohibited. The numeric value range is based on a mean breadth of human index fingers; in case of touching the vicinity of the USB receptacle, frequency of using the index finger is greater than that of other fingers.

### BRIEF DESCRIPTION OF THE DRAWINGS

FIG. 1 is a plan view of the audio player of the present invention.

FIG. 2 is a perspective view of the audio player of the present invention.

FIG. 3 is a perspective view of a cartridge to be attached to the audio player of the present invention, which is seen from the upper side.

FIG. 4 is a perspective view of the cartridge to be attached to the audio player of the present invention, which is seen from the lower side.

FIG. 5 is a plan view of the cartridge to be attached to the audio player of the present invention.

FIG. 6 is a side view of the cartridge to be attached to the audio player of the present invention.

FIG. 7 is a front view of the cartridge to be attached to the audio player of the present invention, which is seen from the front side, in the insertion direction, of the cartridge.

FIG. 8 is a front view of the audio player of the present invention.

FIG. 9 is a bottom view of the audio player of the present invention.

FIG. 10 is a perspective view of the audio player of the present invention, which is seen from the lower side.

FIG. 11 is an explanation view of a protecting section shown in the bottom view of the audio player of the present invention.

FIG. 12 is sample data of breadths of index fingers given by “National Institute of Advanced Industrial Science and Technology”, which are used to define a size of the protecting section, etc. of the audio player of the present invention.

### DESCRIPTION OF PREFERRED EMBODIMENTS OF THE INVENTION

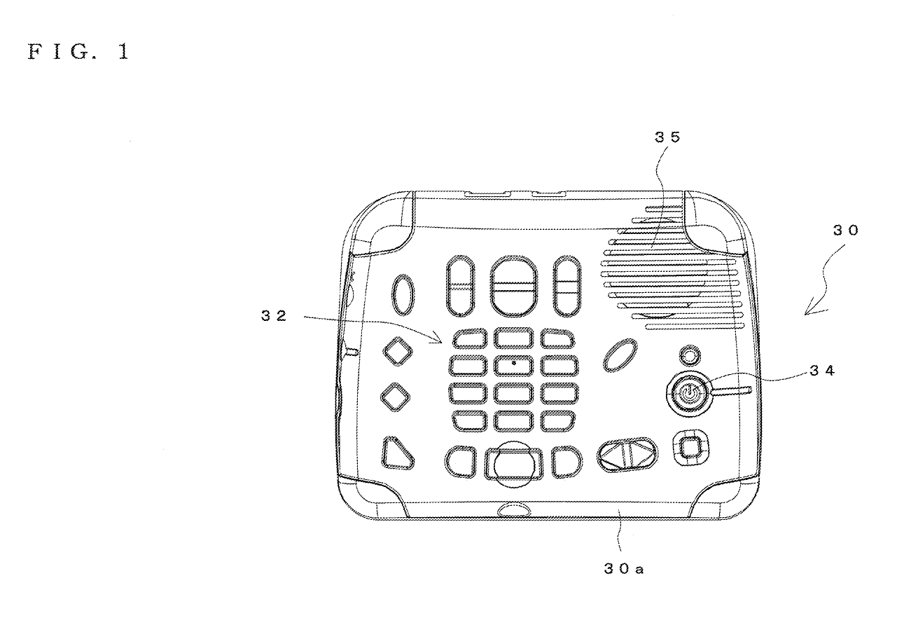

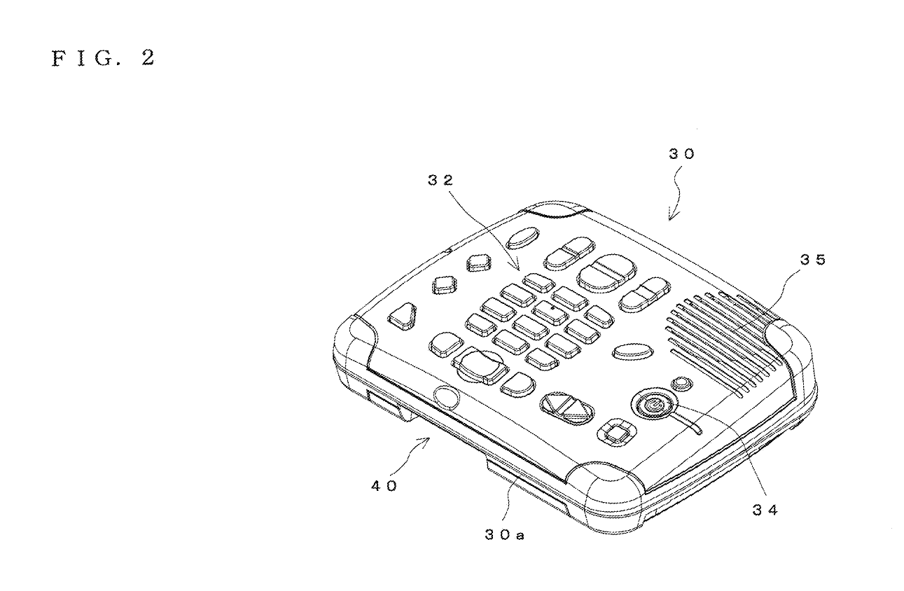

A plan view of the audio player (hereinafter referred to as “player”) of the present invention is shown in FIG. 1, and a perspective view thereof seen from the upper side is shown in FIG. 2.

A planar shape of the player 30 is a rectangular shape constituted by long sides, which are extended in the lengthwise direction, and short sides, which are extended in the crosswise direction, and corners connecting the sides are roundly curved.

A plurality of operating switches 32, a power switch 34 and a speaker 35 are provided in an upper face.

An accommodating section 40, into which a cartridge can be inserted, is opened in a front wall 30a of the player 30.

As described in BACKGROUND OF TECHNOLOGY, the cartridge has a main body section composed of plastic, in which a memory is accommodated, and is formed into a thin rectangular parallelepiped. This cartridge is called “cartridge”, and a structure of the cartridge will be firstly explained.

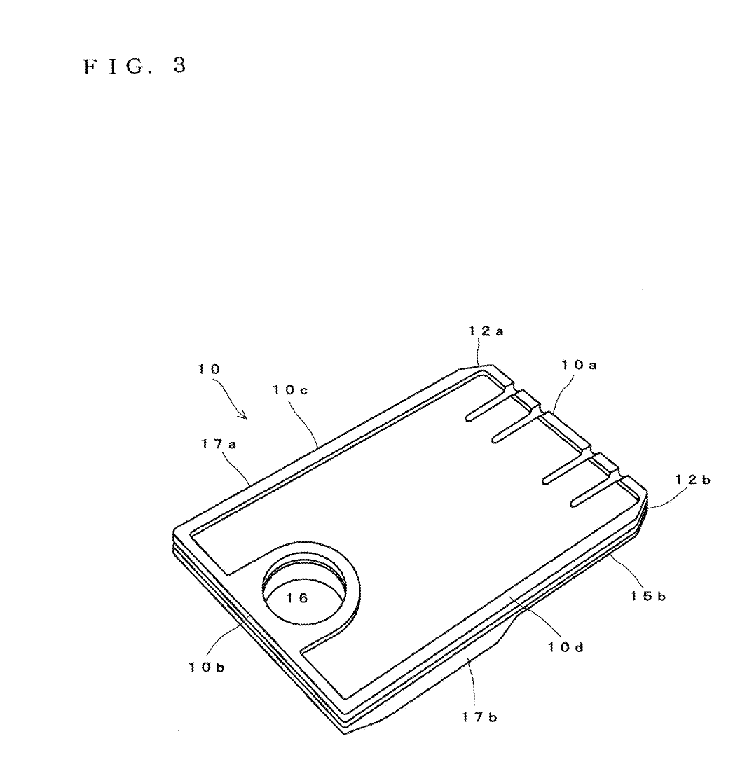

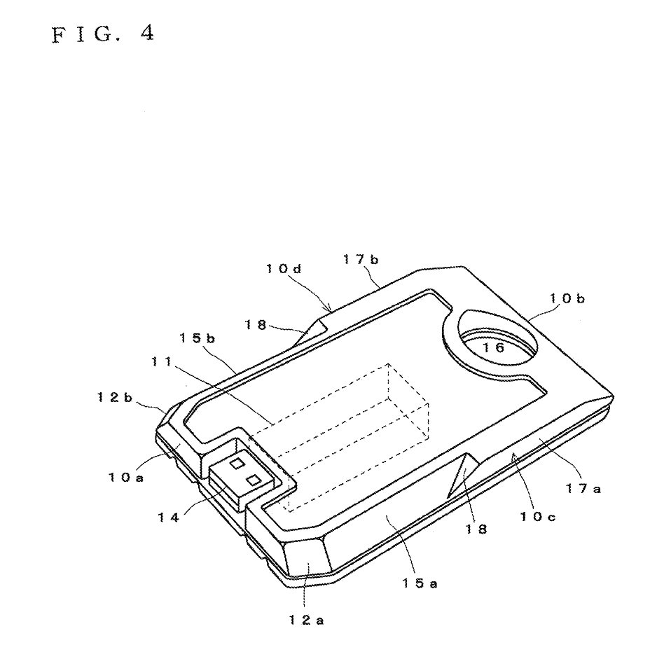

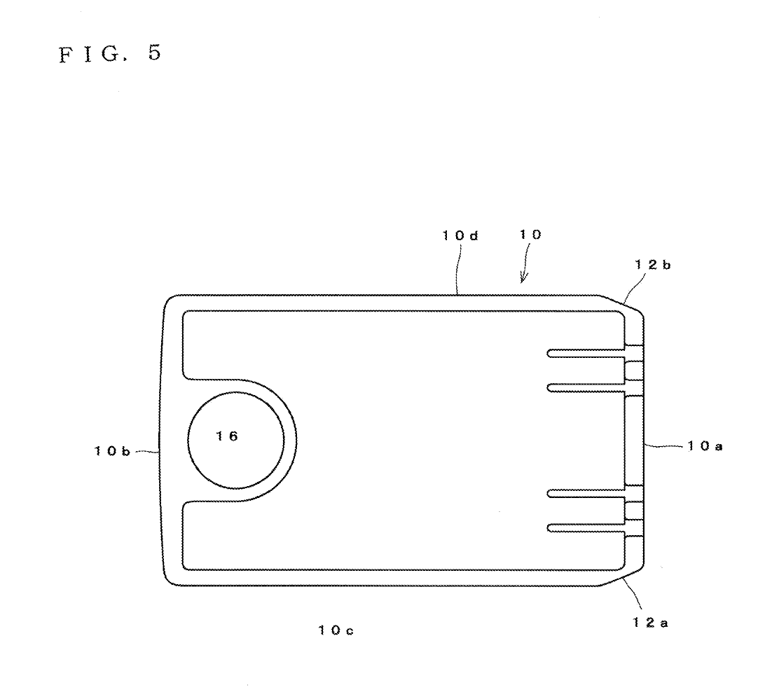

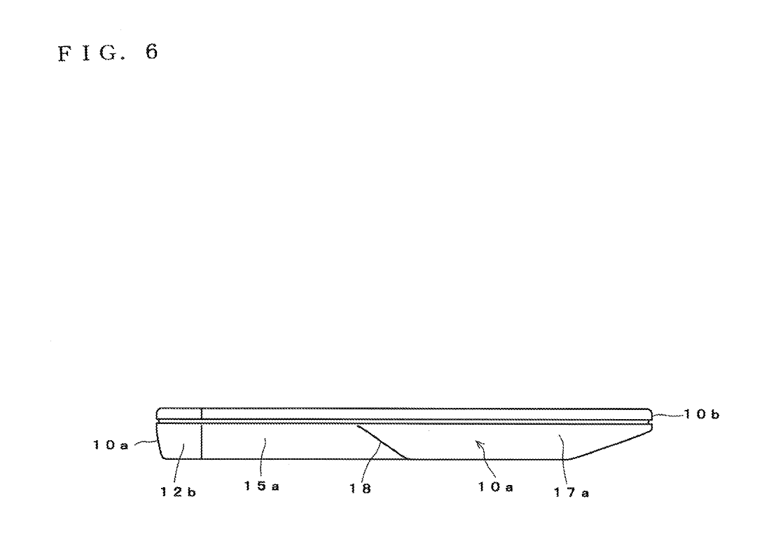

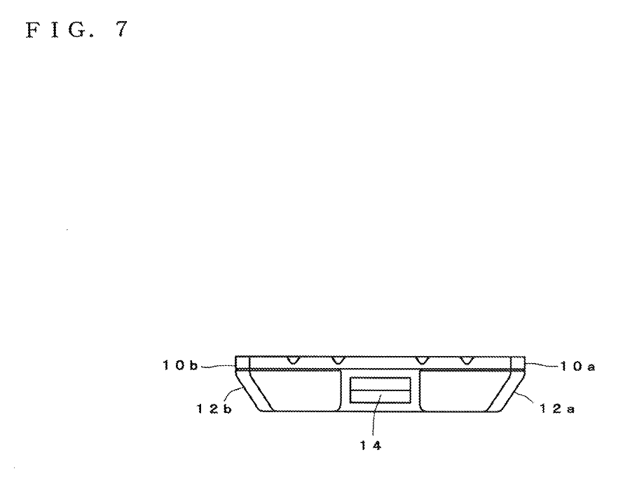

FIGS. 3-7 show the cartridge.

A planar shape of the main body section of the cartridge 10 is a rectangular shape. The rectangular shape is constituted by four sides 10a, 10b, 10c and 10d, and a USB plug 14 is provided to the center of the short side 10a which is a front side in the insertion direction. The USB plug 14 is electrically connected to a memory 11 accommodated in the cartridge 10. These days, USB connectors are popular, so they are suitable as the USB plug 14, etc. However, a type of the USB plug 14 is not limited as a connector.

In the cartridge 10, a through-hole 16, which is formed in the vertical direction (thickness direction), is formed at a rear end in the insertion direction, namely the through-hole is located on the opposite side to the front end where the USB plug 14 is provided. The through-hole 16 has enough diameter, and a user can easily insert an index finger thereinto, so that the user can insert the cartridge 10 into the player 30 in a state where the index finger is inserted in the through-hole 16. Since the through-hole 16 is provided at the rear end in the insertion direction, the user can easily know the rear end and insert the cartridge without misdirecting.

Corners 12a and 12b of the short side 10a, which are located at the front end of the cartridge 10 and connected to the long sides 10c and 10d, are chamfered. In the chamfered corners 12a and 12b, side faces are not formed vertically, they are formed like inverse tapered faces between a bottom face and an upper face, so area of the upper face is made greater than that of the bottom face.

In the front end parts of long sides 10c and 10d of the cartridge 10, the parts are not formed vertically, they are formed like inverse tapered faces between the bottom face and the upper face, so the area of the upper face is made greater than that of the bottom face, as well as the corners 12a and 12b of the front short side 10a.

In the rear end parts of the side faces which are located on the rear side of the inverse tapered side faces 15a and 15b, vertical side faces 17a and 17b are formed. In the long sides 10c and 10d, connection faces 18, each of which connects the inverse tapered side faces 15a or 15b to the vertical side faces 17a or 17b and faces forward in the insertion direction, are formed between the inverse tapered side faces 15a or 15b and the ordinary side faces 17a and 17b.

Successively, the structure of the player 30 will be explained again.

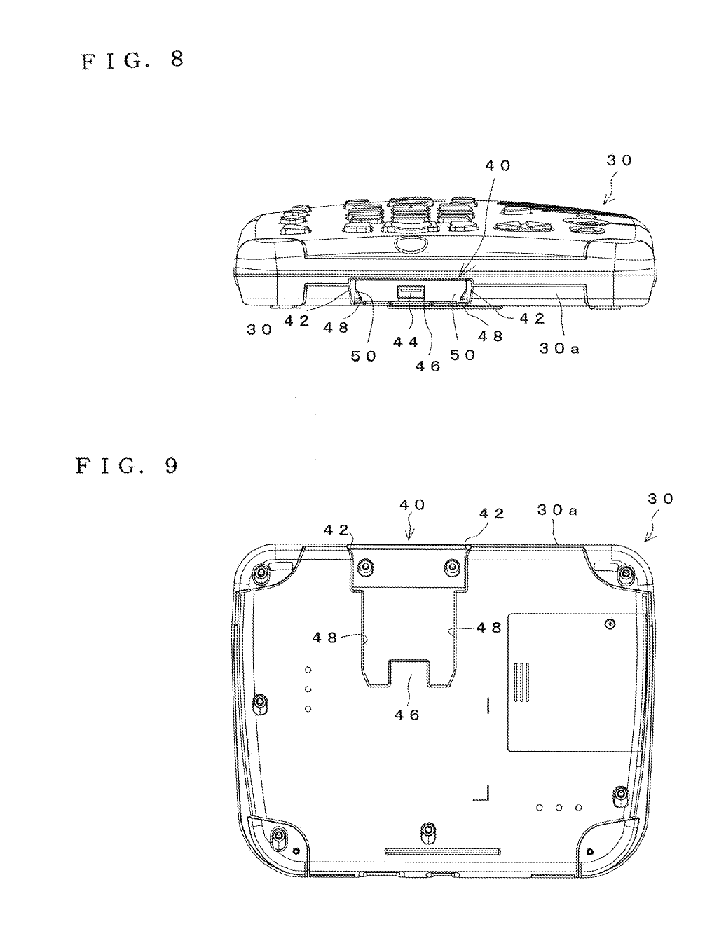

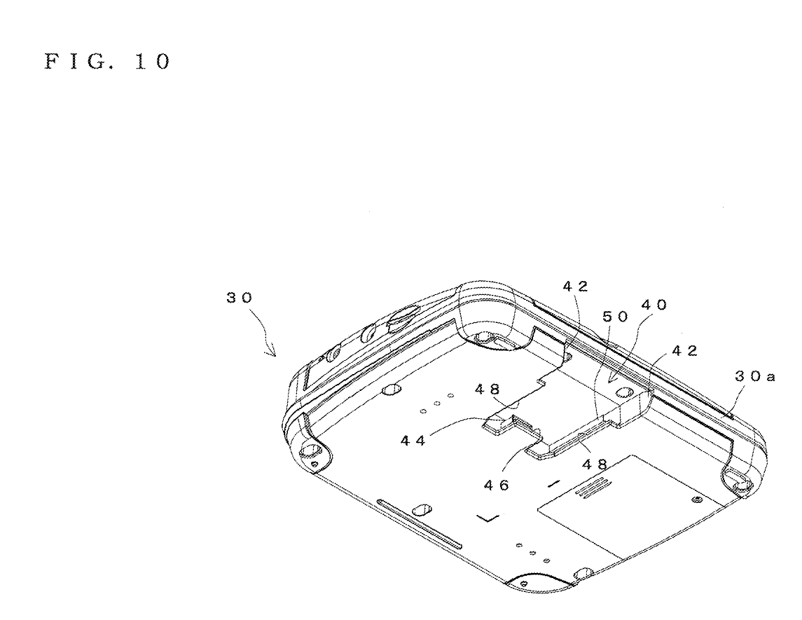

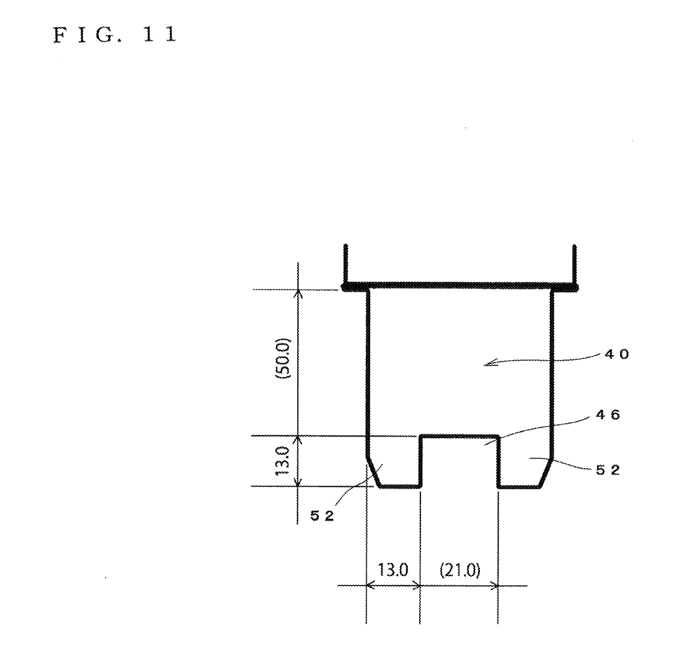

To clearly show the shape of the accommodating section 40, a front view, a bottom view and a perspective view seen from the lower side are shown in FIGS. 8-10.

The above described cartridge 10 will be inserted into the accommodating section 40 of the player 30, and the entire shape of the accommodating section 40 is a rectangular concave, in which a part is cut.

The accommodating section 40 is opened in the front wall 30a. The cartridge 10 is inserted into the accommodating section 40 through an opening part of the front wall 30a of the player 30.

Note that, since a thickness of the player 30 is gradually increased toward a rear end as shown in the side view, the visually-impaired user can easily know the front side. Further, by touching the switches 32 in the upper face, the front side can be easily known.

The accommodating section 40 is designed to expose a part of a flat surface of the inserted cartridge 10. Concretely, in the present embodiment, a bottom part of the accommodating section 40 is opened to expose the bottom face of the cartridge 10.

Tapered faces 42 are formed in both side faces of the opening part of the accommodating section 40 formed in the front wall 30a, and a distance between the tapered faces is gradually increased toward the front face. By forming the tapered faces 42 in the opening part of the accommodating section 40, the tapered faces 42 guide the front end of the cartridge 10 and the cartridge can be smoothly inserted into the accommodating section 40 when the cartridge 10 is inserted. Namely, even if the cartridge 10 is not parallel or is inclined to the longitudinal axis of the accommodating section 40 and the front end of the cartridge 10 contacts the tapered face 42 of the accommodating section 40, the front end of the cartridge 10 moves along the tapered face 42, so that the moving direction of the cartridge 10 is corrected and the cartridge is introduced into the accommodating section 40.

If the tapered faces 42 are linearly formed, the shapes of the tapered faces 42 are discontinued around ends thereof, and the cartridge 10 will be caught when the direction of the cartridge is corrected. Preferably, the vicinity of the ends of the tapered faces 42 are continuously curved so as to smoothly insert the cartridge and prevent the accommodating section 40 from being damaged, namely the tapered faces 42 are not linearly formed. A USB receptacle 44, which can be electrically connected to the USB plug 14 of the cartridge 10, is provided on an innermost face of the accommodating section 40. These days, USB connectors are popular, so they are suitable as the USB receptacle 44. However a type of the USB receptacle 44 is not limited as a connector.

A connector protecting section 46, which is constituted by the bottom part of the player 30, is provided in the opened bottom part of the accommodating section 40 so as to cover a bottom face of the USB receptacle 44, so that the USB receptacle 44 is not exposed in the bottom face of the player. The connector protecting section 46 is formed into a rectangular shape corresponding to the planar shape of the USB receptacle 44 and covers the bottom face of the USB receptacle 44, so that the USB receptacle 44 is not seen from the lower side of the player 30.

Since the connector protecting section 46 is located at the position corresponding to the USB receptacle 44 of the player 30 so as not to expose the connector in the accommodating section 40, the position of the USB receptacle 44 can be easily known and the connectors can be securely connected to each other. Further, injury, which is caused by directly touching the USB receptacle 44, can be prevented.

The connector protecting section 46 is partially projected in the accommodating section 40, whose bottom face is opened, so as to cover the bottom face of the USB receptacle 44. Therefore, even if foreign matters invade into the USB receptacle 44, the foreign matters can be removed from sides of the connector protecting section 46.

Guide sections 48 are formed along lower side edges of the accommodating section 40 and inwardly projected from the both side edges of the accommodating section 40. The both guide sections 48 make a width of the accommodating section 40 slightly smaller than that of the cartridge 10, so the guide sections contact side edges of the bottom face of the cartridge 10. With this structure, by inserting the cartridge 10 into the accommodating section 40, the guide sections 48 contact the side edges of the bottom face of the cartridge 10, a vertical position of the cartridge 10 can be defined and the cartridge 10 can be securely inserted. Further, since the guide sections 48 contact the cartridge 10, shaky motion of the cartridge 10 which has been inserted in the accommodating section 40 can be prevented.

Slope sections 50, in each of which a lower end is located on the inner side with respect to an upper end, are provided lower parts of inner side faces of the accommodating section 40.

Shapes of the slope sections 50 correspond to those of the side faces of the cartridge 10. Namely, the inverse tapered side faces 15a and 15b are formed in the front end parts of the long sides 10c and 10d of the cartridge 10, and the inverse tapered side faces 15a and 15b contact the slope sections 50 in the accommodating section 40. By forming the slope sections 50 capable of contacting the inverse tapered side faces 15a and 15b of the cartridge 10, the cartridge 10 can be correctly positioned and the shaky motion of the cartridge 10 can be prevented in the accommodating section 40.

In case that the player 30 having the above described accommodating section 40 is set on a desk, the cartridge 10 is inserted into the accommodating section 40 of the player 30 by sliding (horizontally moving) the cartridge on the desk, so that the cartridge 10 can be set in the player 30. In this case, lifting the front end of the cartridge 10 upward or inclining the same in the vertical direction is not required.

The opening part of the accommodating section 40 is located near the bottom face of the player 30, and a vertical width of the opening part of the accommodating section 40 (the height from the bottom face of the player 30) is nearly equal to a thickness of the cartridge 10. Therefore, the user can insert the cartridge 10 into the accommodating section 40 without adjusting the vertical position of the cartridge, so the visually-impaired user can easily set the cartridge in the player 30.

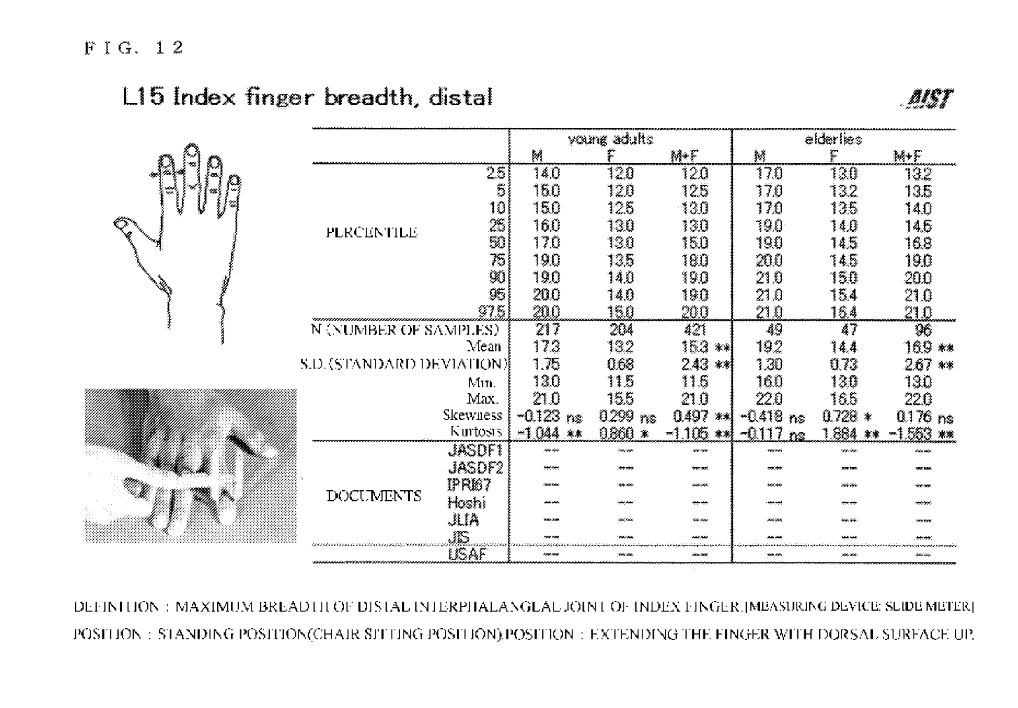

An example of the connector protecting section 46 is shown in FIG. 11. The connector protecting section 46 is provided to prevent the user from being injured by accidentally touching the USB receptacle 44 and to prevent the USB receptacle 44 from being damaged by external impact.

A width of the connector protecting section 46 is smaller than that of an exposed part of the cartridge 40, which is exposed in the accommodating section 40. Therefore, gaps 52 are formed between the connector protecting section 46 and the bottom face of the player 30.

By forming the gaps 52, foreign matters or liquid which has invaded into the accommodating section 40 can be easily removed.

To obtain the effects of easily removing foreign matters or liquid from the accommodating section 40 and using a jig for connecting USB devices, other than the cartridge 10, to the USB receptacle 44, sizes shown in FIG. 11 are employed in the present embodiment.

The width of the gaps formed on the both sides of the connector protecting section 46, i.e., 13 mm, is designed on the basis of sample data of breadth of human index fingers, which will be described later. By employing the size, it is very difficult to insert an index finger into the vicinity of the connector protecting section 46, so that the risk of accidental contact between the USB receptacle 44 and the finger can be highly reduced.

The sample data of breadths of human index fingers are shown in FIG. 12.

The data are cited from a DB of measured values of human parts, which are collected and publicly disclosed by Japan National Institute of Advanced Industrial Science and Technology.

The data can be obtained via the internet, and URL is http://www.dh.aist. go.jp/AIST91DB/91-92/data/list.html.

A range of minimum breadths of index fingers of young and old people is 11.5-16.0 mm, but users of the player 30 of the present invention will be old generations and sample sizes of Japanese people are smaller than those of Westerners, so the medium size, i.e., 13.0 mm, is employed.

What is claimed is:

1. An audio player, to which a cartridge storing digital audio data of a book for the visually impaired can be attached, being capable of reproducing the audio data read from the cartridge,
Wherein an accommodating section, which has an opening part through which the cartridge can be inserted, is formed in at least one of side faces, and
a part of the inserted cartridge is exposed from the accommodating section.

2. The audio player according to claim 1, wherein the accommodating section is formed in the vicinity of a bottom face.

3. The audio player according to claim 1, wherein the bottom side of the accommodating section is opened.

4. The audio player according to claim 1, wherein the accommodating section is located at a prescribed height so as to insert the cartridge, which is located in a plane where the audio player has been set, with horizontally moving the cartridge in the plane.

5. The audio player according to claim 1, wherein linearly-tapered faces, a width of the accommodating section is gradually increased forward linearly, not be formed in the vicinity of corners of the opening part of the accommodating section.

6. The audio player according to claim 5, wherein curved parts are formed in the vicinity of the corners of the opening part of the accommodating section.

7. The audio player according to claim 1, wherein a USB receptacle for electrically connecting to the inserted cartridge is provided on an innermost face of the accommodating section, and
The accommodating section has a protecting section, which covers an exposed face of the USB receptacle so as not to expose it.

8. The audio player according to claim 7, wherein a width of the protecting section is smaller than that of the cartridge, so that gaps are formed on the both sides, in the width direction, of the protecting section, and the recording medium is exposed in the gaps.

9. The audio player according to claim 8, wherein a size of the gaps is 11.5-13.0 mm.
